(19) United States
(12) Patent Application Publication
(10) Pub. No.: US 2014/0288963 A1
(43) Pub. Date: Sep. 25, 2014

(54) METHOD, APPARATUS AND COMPUTER PROGRAM PRODUCT FOR UPDATING ELECTRONIC MEDICAL RECORDS

(71) Applicant: MCKESSON FINANCIAL HOLDINGS, Hamilton (BM)

(72) Inventors: Melissa Frechen, Decatur, GA (US); Wayne Akins, Marietta, GA (US)

(73) Assignee: McKesson Financial Holdings, Hamilton (BM)

(21) Appl. No.: 13/848,189

(22) Filed: Mar. 21, 2013

(51) Int. Cl. G06F 19/00

(52) U.S. Cl. CPC G06F 19/322
USPC 705/3

(57) ABSTRACT

A method for creating medical encounter data. The method may include providing an interface for entry of patient encounter details to a patient medical record. The patient encounter details may be associated with a particular patient clinical encounter. The method may also include determining one or more previous encounters related to the patient medical record, and populating the interface with at least one previous encounter detail associated with at least one of the one or more previous patient encounters. Each of the at least one previous encounter details may be associated with an interface control for selecting the at least one previous encounter detail. The method may also include receiving an indicator of a selection of the interface control. In response to receiving the indicator, the method may add the at least one previous encounter detail associated with the interface control to the patient encounter details. A corresponding computer program product and apparatus are also provided.

### TECHNOLOGICAL FIELD

Embodiments of the present invention relate generally to solutions for providing clinical documentation regarding patient treatment and, more particularly, to a mechanism for updating electronic medical records.

### BACKGROUND

Many aspects of the provision of medical care and the management of many aspects of the healthcare system now involve the use of computers and computer applications. For example, recent efforts have been made to move to electronic medical records (EMR). With clinical documentation systems moving to electronic media, clinical data may be available for incorporation into a number of different applications designed to assist in the management or use of such data. Computerized provider order entry (CPOE) is another example of a development that may improve the ability to electronically access information related to a physician's orders. Many other applications are also being developed to utilize electronic information on people and processes to manage the provision of various aspects of patient care including the provision of predictive care.

As is to be expected, the demand for applications that can be used for streamlining the provision of health care services and the management of health care-related information has led to the development of many new applications by many different providers. However, these applications are often very specific to certain organizations and to certain tasks. As such, certain functionalities or solutions may be tied to specific work environments.

One of the goals of instituting the EMR has been to allow accurate patient health records to be maintained in a manner that can be shared among the potentially many different healthcare providers that a patient may see over time. Thus, the goal of having a single health record that can be manipulated and shared wherever the patient chooses to go for treatment remains. However, despite having this goal in mind, software developers have taken different approaches to making entry of data into an EMR more automated. Thus, it may be unwieldy or difficult to navigate and interpret electronic chart records in some cases. The difficulty may be particularly noticeable in relation to tracking data that corresponds to certain specific visits or encounters.

In many cases, patients may have multiple encounters with a physician for the same medical issue. Chronic conditions, surgical procedures, and the like may require treatment and monitoring over several encounters. Each of these encounters may require separate data entry operations as the practitioner records the patient's symptoms, diagnoses, and treatments separately for each encounter.

### BRIEF SUMMARY

A method, apparatus and computer program product are therefore provided to enable the provision of documentation of clinical encounter history. For example, some embodiments may provide a mechanism by which details of a particular encounter may be recorded as a series of events associated with the particular encounter. An interface may be provided to allow a user to record these events. The mechanism may further access encounter data associated with previous encounters to determine one or more events associated with the previous encounter. The encounter data associated with the previous encounters may be provided via the interface along with a set of interface controls. The interface controls may be associated with particular events, procedures, diagnoses, and the like recorded in the previous encounter. Selection of an interface control may propagate the associated events, procedures, or diagnoses, or the like to a current encounter for which the details are being recorded.

Embodiments may include methods for updating electronic medical records. A method may include providing an interface for entry of patient encounter details to a patient medical record. The patient encounter details may be associated with a particular patient clinical encounter. The method may also include determining one or more previous encounters related to the patient medical record and populating the interface with at least one previous encounter detail associated with at least one of the one or more previous encounters. Each of the at least one previous encounter details may be associated with an interface control for selecting the at least one previous encounter detail. The method may further include receiving an indicator of a selection of the interface control, and in response to receiving the indicator, adding the at least one previous encounter detail associated with the interface control to the patient encounter details.

Embodiments may also include apparatuses for updating electronic medical records. An apparatus may include at least one processor. The at least one processor may be configured to cause the apparatus to provide an interface for entry of patient encounter details to a patient medical record. The patient encounter details may be associated with a particular patient clinical encounter. The apparatus may be further configured to determine one or more previous encounters related to the patient medical record and populate the interface with at least one previous encounter detail associated with at least one of the one or more previous encounters. Each of the at least one previous encounter details may be associated with an interface control for selecting the at least one previous encounter detail. The apparatus may be further configured to receive an indicator of a selection of the interface control, and, in response to receiving the indicator, add the at least one previous encounter detail associated with the interface control to the patient encounter details.

Embodiments may also include computer program products for updating electronic medical records. A computer program product may include a computer readable storage medium. The computer readable storage medium may include program instructions that, when executed by a processor, configure an apparatus. The apparatus may be configured to provide an interface for entry of patient encounter details to a patient medical record. The patient encounter details may be associated with a particular patient clinical encounter. The apparatus may be further configured to determine one or more previous encounters related to the patient medical record, and populate the interface with at least one previous encounter detail associated with at least one of the one or more previous encounters. Each of the at least one previous encounter details may be associated with an interface control for selecting the at least one previous encounter detail. The apparatus may be further configured to receive an indicator of a selection of the interface control, and, in response to receiving the indicator, add the at least one previous encounter detail associated with the interface control to the patient encounter details.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a block diagram illustrating a system for use in connection with providing documentation of clinical encounter history according to some example embodiments;

FIG. 2 is a block diagram showing various components that may be included in an apparatus for providing documentation of clinical encounter history according to some example embodiments;

FIG. 3 illustrates an example data entry interface for accessing previous encounter data according to some example embodiments;

FIG. 4 illustrates an example of an alternative interface for accessing previous encounter data according to some example embodiments; and

FIG. 5 is a block diagram illustrating an example of a method for providing documentation of clinical encounter history using previous encounter data according to some example embodiments.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As indicated above, many different approaches are being taken to improving EMR data entry. Generally speaking, example embodiments of the present invention may facilitate entry of data when recording details of a particular clinical encounter. Example embodiments may provide an interface that accesses prior encounters and allows a practitioner entering the data to select events, diagnostic codes, treatment actions, and the like to be added to a new encounter entry. This interface may reduce repetition of data entry operations by allowing the practitioner to copy data from the previous record without having to reenter repeat data.

Some example embodiments may provide an encounter documentation function that provides a historical record of indicators identifying each chart section for which activities, diagnoses, treatments, and the like have occurred in connection with a particular encounter (or healthcare related visit) associated with a patient. The indicators may be selectable to provide access to the corresponding chart section to review data corresponding to the particular encounter. Encounters, and the corresponding historical record associated with each encounter, may be selected by date or from a sequential listing of encounters. A display of an encounter may include interface controls for propagating events, activities, diagnoses, treatments, and the like from the previous encounter to a new encounter. Accordingly, each indicator associated with each encounter in a patient's record may be selectable to provide one mechanism by which propagation to a new encounter entry may be accomplished. The details of each activity performed in connection with the encounter can therefore easily be appreciated by a practitioner viewing the encounter and/or entering data for a new encounter.

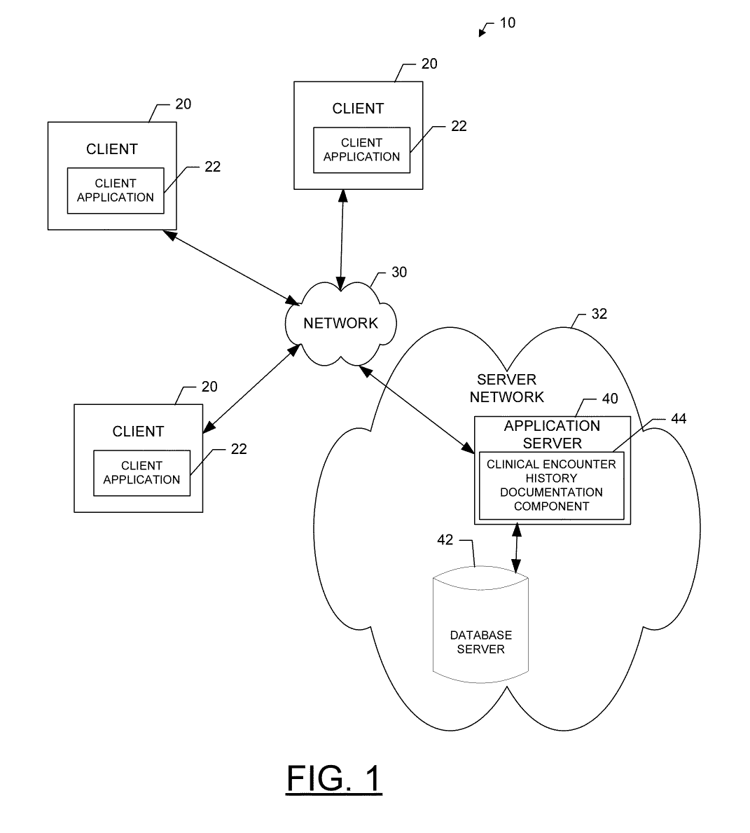

An example embodiment of the invention will now be described in reference to FIG. 1, which illustrates an example system in which an embodiment of the present invention may be employed. As shown in FIG. 1, a system 10 according to an example embodiment may include one or more clients 20 that may, in some cases, be associated with different corresponding healthcare related entities associated with one or more healthcare organizations or systems. For example, among the clients 20, one client may be associated with a first facility and a second client may be associated with a second facility. The facilities (and the corresponding clients) may be within the same healthcare organization or system or the facilities could be associated with different healthcare organizations or systems. As such, in some cases, multiple clients may be associated with the same organization.

Each one of the clients 20 may be, for example, a computer (e.g., a personal computer, laptop computer, network access terminal, or the like) or may be another form of computing device (e.g., a personal digital assistant (PDA), cellular phone, smart phone, or the like) capable of communication with a network 30. As such, for example, each one of the clients 20 may include (or otherwise have access to) memory for storing instructions or applications for the performance of various functions and a corresponding processor for executing stored instructions or applications. Each one of the clients 20 may also include software and/or corresponding hardware for enabling the performance of the respective functions of the clients as described below. In an example embodiment, one or more of the clients 20 may include a client application 22 configured to operate in accordance with an example embodiment of the present invention. In this regard, for example, the client application 22 may include software for enabling a respective one of the clients 20 to communicate with the network 30 for requesting and/or receiving a clinical encounter history documentation component in the form of a deliverable component (e.g., as downloadable software to configure the client, or as a transferable memory device including instructions to configure the client). As such, for example, the client application 22 may include corresponding executable instructions for configuring the client 20 to provide corresponding functionalities as described in greater detail below.

The network 30 may be a data network, such as a local area network (LAN), a metropolitan area network (MAN), a wide area network (WAN) (e.g., the Internet), and/or the like, which may couple the clients 20 to devices such as processing elements (e.g., personal computers, server computers or the like) or databases. Communication between the network 30, the clients 20 and the devices or databases (e.g., servers) to which the clients 20 are coupled may be accomplished by either wireline or wireless communication mechanisms and corresponding protocols.

In an example embodiment, one of the devices to which the clients 20 may be coupled via the network 30 may include one or more application servers (e.g., application server 40), and/or a database server 42, which together may form respective elements of a server network 32. Although the application server 40 and the database server 42 are each referred to as “servers,” this does not necessarily imply that they are embodied on separate servers or devices. As such, for example, a single server or device may include both entities, and the database server 42 could merely be represented by a database or group of databases physically located on the same server or device as the application server 40. The application server 40 and the database server 42 may each include hardware and/or software for configuring the application server 40 and the database server 42, respectively, to perform various functions. As such, for example, the application server 40 may include processing logic and memory enabling the application server 40 to access and/or execute stored computer readable instructions for performing various functions. In an example embodiment, one function that may be provided by the application server 40 may be the provision of a clinical encounter history documentation component or the provision of services provided by a clinical encounter history documentation component of an example embodiment.

In some embodiments, for example, the application server 40 may therefore include an instance of a clinical encounter history documentation component 44 comprising stored instructions for handling activities associated with practicing example embodiments as described herein. As such, in some embodiments, the clients 20 may access the clinical encounter history documentation component 44 online and utilize the services provided thereby. However, it should be appreciated that in other embodiments, the clinical encounter history documentation component 44 may be provided from the application server 40 (e.g., via download over the network 30) to one or more of the clients 20 to enable recipient clients to instantiate an instance of the clinical encounter history documentation component 44 for local operation. As yet another example, the clinical encounter history documentation component 44 may be instantiated at one or more of the clients 20 responsive to downloading instructions from a removable or transferable memory device carrying instructions for instantiating the clinical encounter history documentation component 44 at the corresponding one or more of the clients 20. In such an example, the network 30 may not be needed or utilized at all.

In an example embodiment, the application server 40 may include or have access to memory (e.g., internal memory or the database server 42) for storing instructions or applications for the performance of various functions and a corresponding processor for executing stored instructions or applications. For example, the memory may store an instance of the clinical encounter history documentation component 44 configured to operate in accordance with an example embodiment of the present invention. In this regard, for example, the clinical encounter history documentation component 44 may include software for enabling the application server 40 to communicate with the network 30 and/or the clients 20 for the provision and/or receipt of information associated with performing clinical documentation as described herein.

As such, the environment of FIG. 1 illustrates an example in which provision of clinical encounter history documentation (e.g., in a healthcare record or EMR) may be accomplished by a particular entity (namely the clinical encounter history documentation component 44 residing at the application server 40). However, it should be noted again that the clinical encounter history documentation component 44 could alternatively handle provision of clinical documentation support within a single facility. Thus, in some embodiments, the clinical encounter history documentation component 44 may be embodied at one or more of the clients 20 and, in such an example, the clinical encounter history documentation component 44 may be configured to handle provision of clinical encounter history documentation support only for the corresponding facility.

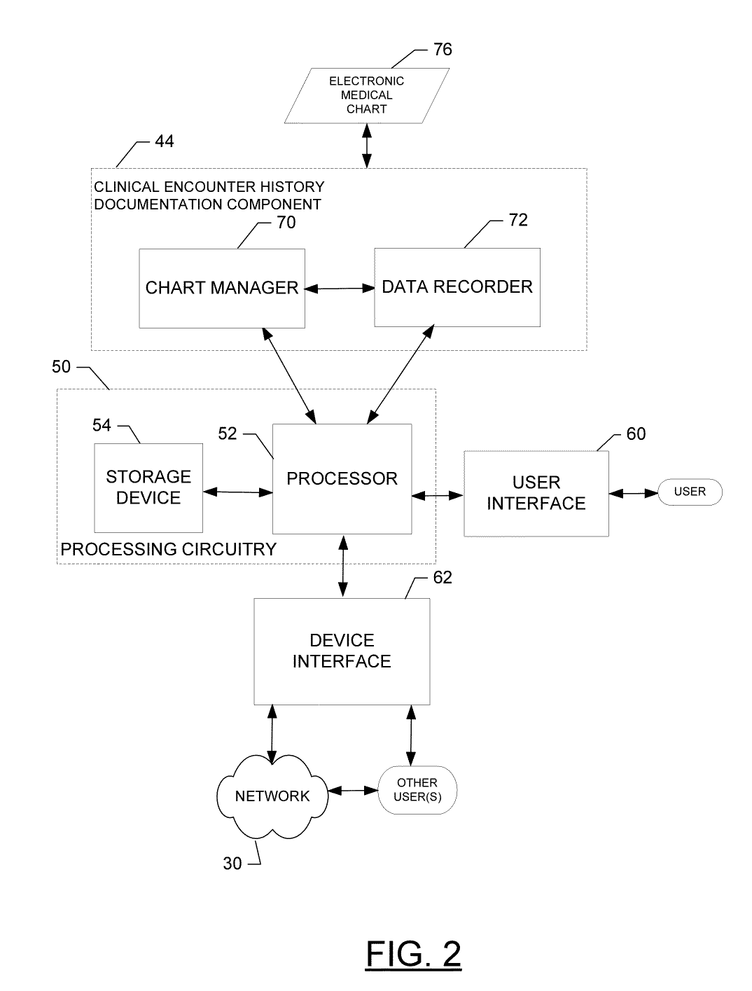

An example embodiment of the invention will now be described with reference to FIG. 2. FIG. 2 shows certain elements of an apparatus for provision of clinical encounter history documentation support according to an example embodiment. The apparatus of FIG. 2 may be employed, for example, on a client (e.g., any of the clients 20 of FIG. 1) or a variety of other devices (such as, for example, a network device, server, proxy, or the like (e.g., the application server 40 of FIG. 1)). Alternatively, embodiments may be employed on a combination of devices. Accordingly, some embodiments of the present invention may be embodied wholly at a single device (e.g., the application server 40 or one or more clients 20) or by devices in a client/server relationship (e.g., the application server 40 and one or more clients 20). Furthermore, it should be noted that the devices or elements described below may not be mandatory and thus some may be omitted in certain embodiments.

Referring now to FIG. 2, an apparatus for provision of clinical encounter history documentation support is provided. The apparatus may include or otherwise be in communication with processing circuitry 50 that is configured to perform data processing, application execution and other processing and management services according to an example embodiment of the present invention. In one embodiment, the processing circuitry 50 may include a storage device 54 and a processor 52 that may be in communication with or otherwise control a user interface 60 and a device interface 62. As such, the processing circuitry 50 may be embodied as a circuit chip (e.g., an integrated circuit chip) configured (e.g., with hardware, software or a combination of hardware and software) to perform operations described herein. However, in some embodiments, the processing circuitry 50 may be embodied as a portion of a server, computer, laptop, workstation or even one of various mobile computing devices. In situations where the processing circuitry 50 is embodied as a server or at a remotely located computing device, the user interface 60 may be disposed at another device (e.g., at a computer terminal or client device such as one of the clients 20) that may be in communication with the processing circuitry 50 via the device interface 62 and/or a network (e.g., network 30).

The user interface 60 may be in communication with the processing circuitry 50 to receive an indication of a user input at the user interface 60 and/or to provide an audible, visual, mechanical or other output to the user. As such, the user interface 60 may include, for example, a keyboard, a mouse, a joystick, a display, a touch screen, a microphone, a speaker, a cell phone, or other input/output mechanisms. In embodiments where the apparatus is embodied at a server or other network entity, the user interface 60 may be limited or even eliminated in some cases.

The device interface 62 may include one or more interface mechanisms for enabling communication with other devices and/or networks. In some cases, the device interface 62 may be any means such as a device or circuitry embodied in either hardware, software, or a combination of hardware and software that is configured to receive and/or transmit data from/to a network and/or any other device or module in communication with the processing circuitry 50. In this regard, the device interface 62 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 62 communicates with a network, the network may be any of various examples of wireless or wired communication networks such as, for example, data networks like a Local Area Network (LAN), a Metropolitan Area Network (MAN), and/or a Wide Area Network (WAN), such as the Internet.

In an example embodiment, the storage device 54 may include one or more non-transitory storage or memory devices such as, for example, volatile and/or non-volatile memory that may be either fixed or removable. The storage device 54 may be configured to store information, data, applications, instructions or the like for enabling the apparatus to carry out various functions in accordance with example embodiments of the present invention. For example, the storage device 54 could be configured to buffer input data for processing by the processor 52. Additionally or alternatively, the storage device 54 could be configured to store instructions for execution by the processor 52. As yet another alternative, the storage device 54 may include one of a plurality of databases (e.g., database server 42) that may store a variety of files, contents or data sets. Among the contents of the storage device 54, applications (e.g., client application 22 or service application such as the clinical encounter history documentation component 44) may be stored for execution by the processor 52 in order to carry out the functionality associated with each respective application.

The processor 52 may be embodied in a number of different ways. For example, the processor 52 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 52 may be configured to execute instructions stored in the storage device 54 or otherwise accessible to the processor 52. As such, whether configured by hardware or software methods, or by a combination thereof, the processor 52 may represent an entity (e.g., physically embodied in circuitry) capable of performing operations according to embodiments of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor 52 to perform the operations described herein.

In an example embodiment, the processor 52 (or the processing circuitry 50) may be embodied as, include or otherwise control the clinical encounter history documentation component 44, which may include or otherwise control a chart manager 70 and a data recorder 72. The chart manager 70 and the data recorder 72 may each be any means such as a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or circuitry to perform the corresponding functions of the chart manager 70 and the data recorder 72, respectively, as described below.

The clinical encounter history documentation component 44 may be a component of, or may itself be, a tool for managing EMRs or other electronic patient health records, generally referred to hereinafter as a chart (e.g., electronic medical chart 76). As such, the clinical encounter history documentation component 44 may be configured to provide an interface for inputting data, modifying data and/or saving data to charts associated with various different patients. The chart manager 70 and the data recorder 72 may enable a user to interface with the chart to facilitate data entry into the chart, and to provide for recordation of a history of activities performed with respect to the patient on a per-encounter basis as described in greater detail below. The chart manager 70 and/or the data recorder 72 may be further configured to retrieve data corresponding to previous encounters for a particular patient to assist with the entry of data for a new encounter, such as during a recording operation performed by the data recorder 72.

In an example embodiment, the chart manager 70 may be configured to provide a structured organization of pages and/or interfaces to be presented to the user to represent corresponding sections of the chart. Thus, for example, the chart manager 70 may be configured to present a sequence of topic segregated pages for the entry or viewing of data related to healthcare related activities undertaken with respect to a patient. The chart manager 70 may support the creation of separate files for corresponding different patients with a common structure for the data stored in association with each file to form a corresponding patient chart. Each section of the chart may have a structure and interfaces designed to permit entry and review of data corresponding to a particular healthcare related topic for the patient. The chart manager 70 may be configured to provide the structure for the chart so that the data associated with each file can be viewed and various sections of the chart can be navigated between using the interfaces provided by the chart manager 70.

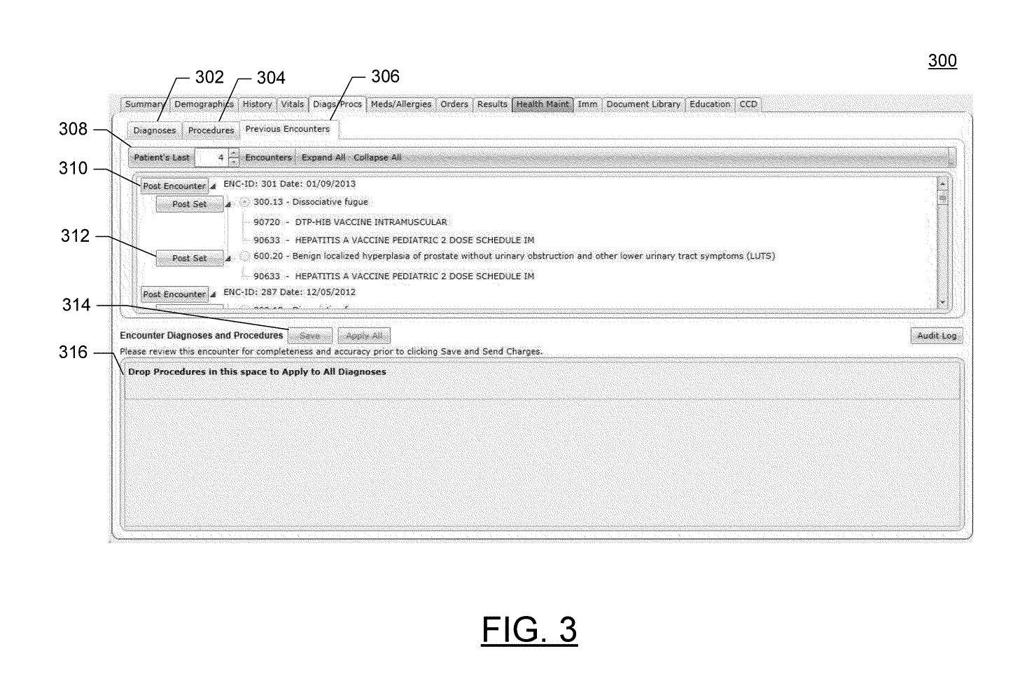

FIG. 3 illustrates an example of data entry interface 300 for accessing previous encounter data according to some example embodiments. As described above, embodiments may provide for the entry of patient encounter data to a medical record system. Data may be entered and stored in association with a patient. When the patient is initially entered into the system, much of the demographic data, contact information, and other general data may be entered into the record to create the chart. Other data and chart sections will be filled in and utilized to store records of patient data for various visits or encounters that occur with the patient over time. For example, encounters may be associated with a particular set of diagnosis codes related to the symptoms or medical conditions the patient is experiencing, and a set of procedure codes associated with procedures performed on or prescribed for the patient during the encounter. Some or all of these codes may also include modifiers. These modifiers may provide additional context or granularity of data to a particular procedure code relating to specific details of the procedure(s) performed. For example, a hand x-ray may have a single procedure code, but a modifier may be applied to the procedure code to indicate whether the x-ray is for the patient's left hand or right hand. When a patient is seen or receives treatment on any particular visit, only some of the data in any particular chart section may need to be modified to accommodate applicable changes and only some of the chart sections may be utilized to enter new data.

The interface 300 depicts an example of an interface for accessing, storing, and creating encounter data. For example, the interface 300 may be provided as part of an implementation of a client 20 as described with respect to FIG. 1, or a clinical encounter history documentation component 44 or data recorder 72 as described with respect to FIG. 2. The interface 300 shows a series of interface controls that allow a user, such as a medical practitioner, to view and enter data about patient diagnoses, procedures, and the like for a current patient encounter for which the user wishes to record data. The current encounter may be linked to a particular patient and thus the interface may be able to determine which other records are associated with the patient. For example, an application server, such as the application server 40 described with respect to FIG. 1, may store data for a plurality of clinical encounters for a particular patient, and upon selection of a particular patient, data for the patient's previous encounters may be retrieved from a patient record database and used to populate the interface 300 with data from the previous encounters. The interface 300 thus provides the ability to access these stored medical records to assist the user with data entry for a new encounter record.

The interface 300 may include multiple tabs to access different data entry fields. A previous encounters tab 306 may provide a set of interface controls for viewing, accessing, and selecting data associated with previous encounters that are relevant to the current encounter. Embodiments may generally provide the ability to view prior encounters for the same patient, although alternative embodiments may provide access to other encounters. For example, additionally or alternatively to providing access to prior patient encounters, the previous encounters tab 306 may provide for access to a “frequently used” set of encounter data based on previous entries performed by the user (e.g., a set of encounter data most frequently entered for encounters by a given medical practitioner).

The previous encounters tab 306 may include a counter 308. The counter 308 may provide an interface control by which the user may scroll through previous encounter records. For example, selection of an up arrow next to the counter 308 may move the user to a next encounter. In some embodiments, the order in which encounters are presented may be related to the date or time of the encounter. For example, encounter records may be displayed in reverse-chronological order, such that increasing the counter 308 moves the user back through the patient's encounter history in reverse order of which the encounters occurred. Alternatively, the counter 308 may determine how many encounter records are displayed in the previous encounters tab 306. For example, if the counter 308 has a value of “4”, then the previous encounters tab 306 may be populated with data for the patient's 4 most recent encounters.

The previous encounters tab 306 may include a post encounter control 310 and a post set control 312. These controls 310, 312 may allow for posting of particular data associated with the control to the encounter for which the user is entering data. For example, the post encounter control 310 may add all diagnostic codes and/or operations associated with a particular encounter to the encounter for which the user is entering data. The post set control 312 may add a particular set of data (e.g., a particular diagnostic or procedure code) from the previous encounter to the encounter for which the user is entering data. Selection of the post encounter control 310 or the post set control 312 may also include propagation of any modifiers associated with the encounter or set, respectively, such as the x-ray modifier as described above. In some embodiments, selection of a particular control to post the data to the current encounter for which the user is entering data may cause a change to the interface. For example, upon selecting the post encounter control 310 for an encounter, that encounter may be “grayed out” or the post encounter control 310 may be disabled, to indicate to the user that the data has already been propagated to the current encounter. Upon selection of one of the controls 310, 312, the data associated with the particular control may be sent to the diagnoses tab 302 or the procedures tab 304, or otherwise associated with the current medical record.

Additional tabs may also provide access to patient data associated with previous encounters. For example, a diagnoses tab 302 may provide the user with an interface to select among each of the diagnosis codes entered for the patient during previous encounters. Similarly, a procedures tab 304 may provide the user with an interface to select from among a set of procedures associated with previous encounters for the patient. Information provided by the diagnoses tab 302 and the procedures tab 304 may present such information in a list format. This list format may be in contrast to an encounter delimited format as described above with respect to the previous encounters tab 306.

Data propagated from other encounters may be copied in an editable format such that the user may be permitted to modify the data prior to confirming the current encounter data. For example, diagnosis and procedure codes selected for the current encounter may be propagated to an editable encounter area 316, such as depicted in the interface 300 below the area where the user selects codes. In some embodiments, codes may be added to the particular encounter via a drag and drop interface, where codes are added to the encounter upon being dragged from one of the tabs 302, 304, 306 to the editable encounter area 316. Codes added to the encounter via the drag and drop interface or via selection of other interface controls (e.g., the post encounter control 310 or the post set control 3312) may appear in the editable encounter area 316 for editing and review prior to being saved to the encounter. As an example, the user may wish to propagate all of the data from a prior encounter, but then delete or add a particular diagnosis code. As such, the user may select the interface control associated with the particular prior encounter, and then edit the propagated data in the editable encounter area 316 before the data is committed to the newly created encounter. For example, the interface 300 may further provide a save control 314 to allow the user to save the current record and thus submit any selections.

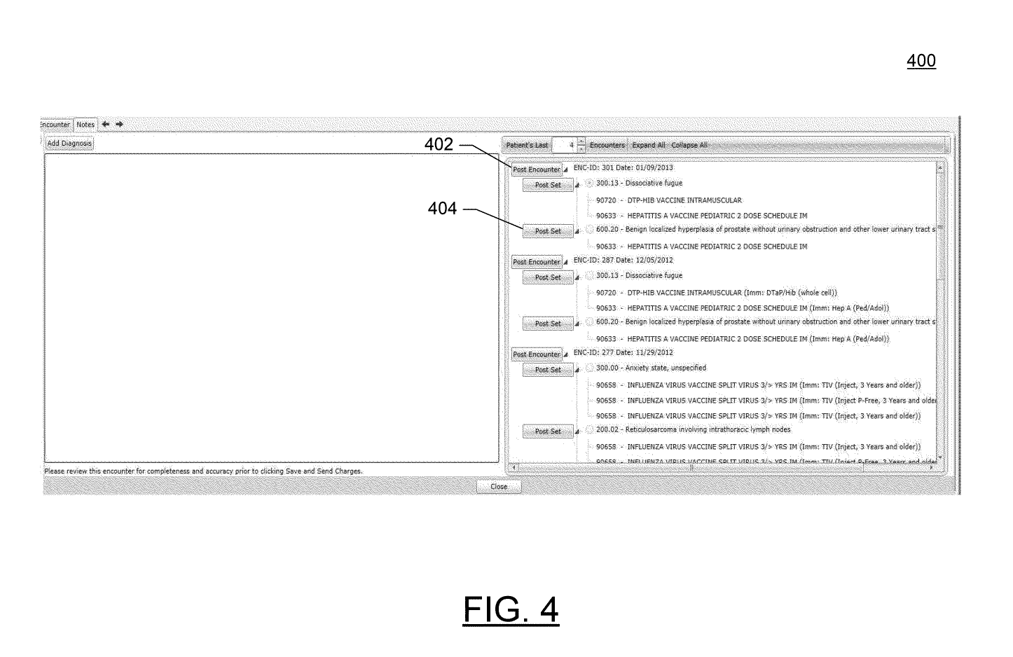

FIG. 4 illustrates an example of an alternative interface 400 for accessing previous encounter data according to some example embodiments. The interface 400 provides an alternative interface for populating a current encounter with data from previous patient encounters. As with the interface 300 described above with respect to FIG. 3, the interface 400 includes a post encounter control 402 and a post set control 404. When selected by the user, the post encounter control 402 and the post set control 404 may cause posting of the data associated with the selected control to the current encounter.

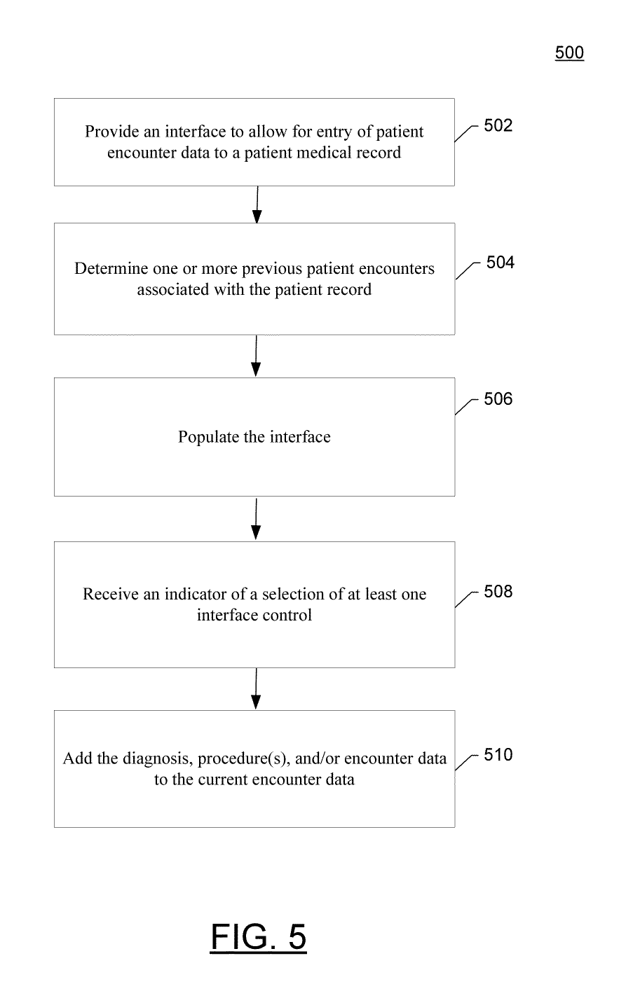

Embodiments may therefore be practiced using an apparatus such as the one depicted in FIG. 2. However, other embodiments may be practiced in connection with a computer program product for performing embodiments of the present invention. FIG. 5 is a flowchart of a method and program product according to example embodiments of the invention. The method 500 may be employed to provide documentation of a clinical encounter using previous encounter data according to some example embodiments. Each block or step of the flowchart of FIG. 5, and combinations of blocks in the flowchart, may be implemented by various means, such as hardware, firmware, processor, circuitry and/or another device associated with execution of software including one or more computer program instructions. Thus, for example, one or more of the procedures described above may be embodied by computer program instructions, which may embody the procedures described above and may be stored by a storage device (e.g., storage device 54) and executed by processing circuitry (e.g., processor 52).

As will be appreciated, any such stored computer program instructions may be loaded onto a computer or other programmable apparatus (i.e., hardware) to produce a machine, such that the instructions which execute on the computer or other programmable apparatus implement the functions specified in the flowchart block(s). These computer program instructions may also be stored in a non-transitory computer-readable storage medium comprising memory that may direct a computer or other programmable apparatus to function in a particular manner, such that the instructions stored in the computer-readable memory produce an article of manufacture including instructions to implement the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

In this regard, a method according to one embodiment of the invention, as shown in FIG. 5, may include providing for display of an interface whereby a user may select from data associated with previous medical encounters to add or edit a current encounter entry. It should be readily appreciated that the method may be performed wholly or partially on either or both of a client device or an application server, and that the method described herein is not intended to be limited to a particular device. For example, an interface may be provided by a client device by an application executing on the client device, or as a web page hosted and/or provided by a server. As another example, both a client and server may be configured to initiate queries to identify particular records as described herein.

At action 502, an interface is provided to allow for entry of patient encounter data to a patient medical record. As described above with respect to FIGS. 1 and 2, the interface may be provided by an application server in communication with a client device. For example, a client device may include an application for allowing a user to enter data associated with an encounter, and the application server may function to provide the client device with an interface by sending and receiving data to and from the client device to allow the client device to interact with a medical records system provided by the application server. The interface may be populated with data for a particular patient. For example, the user may select the patient prior to causing execution of a medical encounter entry operation. Selection of the patient may populate various fields with information about the patient, such as the patient's name, address, and other demographic information.

At action 504, other encounters are determined based on the patient. For example, as described above, previous encounters associated with the patient may be identified, such as by performing a database query on a medical records database using an identification of the patient (e.g., a unique value associated with the patient). It should be readily appreciated that medical records for the patient may be determined in a variety of manners. For example, a medical records request may be performed using a health information exchange system to obtain medical records from providers other than a provider entering the encounter data. Although the present example discloses determination of medical records that are related to prior encounters for the particular patient, it should be readily appreciated that alternative methods of determining the other encounters may be employed. For example, data for other encounters associated with a particular healthcare provider or practitioner may be identified to obtain information about the preferences of the particular organization or practitioner.

At action 506, the interface is populated with data derived from the encounters identified at action 504. This data may include data pertaining to the identified previous records for the patient. For example, previous encounters may be displayed according to an interface such as described with respect to FIGS. 3 and 4, such that the interface is populated with diagnosis and procedure codes from the previous encounter, along with one or more interface controls associated with the diagnosis codes, procedure codes, or encounters. The interface may be populated by sending data about the identified previous encounters over a network to the interface. For example, a client device allowing the user to interact with the interface may receive the data derived from the encounters as one or more network data packets.

At action 508, an indication of a selection of one of the interface controls is received. For example, a user of the client device may select a “button” control associated with a particular code or encounter. The indication may thus be a local selection of the interface control (e.g., initiating processing upon a mouse click action performed on a local interface), or remote selection (e.g., receiving a network data packet indicating that a user of a client device has selected a particular interface control).

At action 510, the data associated with the selected encounter is added to the current encounter for which the user is adding data. For example, the user may select an interface control associated with a prior encounter, and all diagnosis and procedure codes associated with the selected prior encounter may be propagated to the current encounter, or the user may select a particular diagnosis code and only that diagnosis code may be propagated to the current encounter. As described above, selection of particular data may, in some embodiments, propagate the data to an editable field or window such that the user may modify the propagated data before committing the data to the current encounter.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
providing an interface for entry of patient encounter details to a patient medical record, the patient encounter details associated with a particular patient clinical encounter;
determining one or more previous encounters related to the patient medical record;
populating the interface with at least one previous encounter detail associated with at least one of the one or more previous encounters, each of the at least one previous encounter details associated with an interface control for selecting the at least one previous encounter detail;
receiving an indicator of a selection of the interface control; and
in response to receiving the indicator, adding the at least one previous encounter detail associated with the interface control to the patient encounter details.

2. The method of claim 1, wherein the previous encounter detail comprises at least one of a diagnosis code, a procedure code, or a previous encounter.

3. The method of claim 2, wherein the previous encounter detail further comprises any modifiers associated with the diagnosis code, the procedure code, or the previous encounter.

4. The method of claim 1, wherein the one or more previous encounters are previous encounters for a same patient for which the patient encounter details are entered.

5. The method of claim 1, wherein the one or more previous encounters are previous encounters created by a medical practitioner entering the patient encounter details.

6. The method of claim 1, wherein the at least one previous encounter detail is added to an editable interface, and the method further comprises modifying the at least one previous encounter detail before adding the previous encounter detail to the patient medical record.

7. The method of claim 1, further comprising providing an interface control for selection of a number of the determined previous encounters to display.

8. The method of claim 1, further comprising providing an interface control for selecting a particular one of the determined previous encounters.

9. An apparatus comprising at least one processor, the at least one processor configured to cause the apparatus to:
provide an interface for entry of patient encounter details to a patient medical record, the patient encounter details associated with a particular patient clinical encounter;
determine one or more previous encounters related to the patient medical record;
populate the interface with at least one previous encounter detail associated with at least one of the one or more previous encounters, each of the at least one previous encounter details associated with an interface control for selecting the at least one previous encounter detail;
receive an indicator of a selection of the interface control; and
in response to receiving the indicator, add the at least one previous encounter detail associated with the interface control to the patient encounter details.

10. The apparatus of claim 9, wherein the previous encounter detail comprises at least one of a diagnosis code, a procedure code, or a previous encounter.

11. The apparatus of claim 10, wherein the previous encounter detail further comprises any modifiers associated with the diagnosis code, the procedure code, or the previous encounter.

12. The apparatus of claim 9, wherein the one or more previous encounters are previous encounters for a same patient for which the patient encounter details are entered.

13. The apparatus of claim 9, wherein the one or more previous encounters are previous encounters created by a medical practitioner entering the patient encounter details.

14. The apparatus of claim 9, wherein the at least one previous encounter detail is added to an editable interface, and the method further comprises modifying the at least one previous encounter detail before adding the previous encounter detail to the patient medical record.

15. The apparatus of claim 9, wherein the processor is further configured to cause the apparatus to provide an interface control for selection of a number of the determined previous encounters to display.

16. The apparatus of claim 9, wherein the processor is further configured to cause the apparatus to provide an interface control for selecting a particular one of the determined previous encounters.

17. A computer program product comprising a computer readable storage medium, the computer readable storage medium comprising program instructions that, when executed by a processor, configure an apparatus to:
provide an interface for entry of patient encounter details to a patient medical record, the patient encounter details associated with a particular patient clinical encounter;
determine one or more previous encounters related to the patient medical record;
populate the interface with at least one previous encounter detail associated with at least one of the one or more previous encounters, each of the at least one previous encounter details associated with an interface control for selecting the at least one previous encounter detail;
receive an indicator of a selection of the interface control; and
in response to receiving the indicator, add the at least one previous encounter detail associated with the interface control to the patient encounter details.

18. The computer program product of claim 17, wherein the previous encounter detail comprises at least one of a diagnosis code, a procedure code, or a previous encounter.

19. The computer program product of claim 18, wherein the previous encounter detail further comprises any modifiers associated with the diagnosis code, the procedure code, or the previous encounter.

20. The computer program product of claim 17, wherein the one or more previous encounters are previous encounters for a same patient for which the patient encounter details are entered.
